(19) United States
(12) Patent Application Publication
(10) Pub. No.: US 2005/0115378 A1
(43) Pub. Date: Jun. 2, 2005

(54) Slicing machine with automatic product alignment

(76) Inventor: Fritz Kuchler, Klagenfurt (AT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/984,553

(22) Filed: Nov. 8, 2004

(30) Foreign Application Priority Data
Nov. 7, 2003 (AT) A1790/2003

(51) Int. Cl. B26D 7/00; B27B 5/02

(52) U.S. Cl. 83/707; 83/932

(57) ABSTRACT

A slicing machine has a blade displaceable on a housing, a housing plate on the housing extending parallel to a cutting direction adjacent the blade, and a slide adapted to support a foodstuff to be sliced, displaceable parallel to the direction on the housing past the blade, and having a holding face extending perpendicular to the direction. An array of parallel and horizontal alignment bars oriented in a plane extending parallel to the holding face on the slide are displaceable parallel to the direction relative to the holding face. An alignment guide or drive allows movement of the alignment bars parallel to the direction toward the holding face and thereby pressing and aligning of the foodstuff thereagainst. A similar array of parallel and horizontal pusher bars press the foodstuff between the alignment bars and the holding face toward the housing plate.

### FIELD OF THE INVENTION

The present invention relates to a slicing machine. More particularly this invention concerns a slicing machine of the type used in a delicatessen or food store for cutting up luncheon meat, cheese, and the like into slices.

### BACKGROUND OF THE INVENTION

A standard slicing machine has a housing, an upright blade rotatable by a motor on the housing, and a slide adapted to hold a sliceable foodstuff and displaceable in a cutting direction past the blade. A normally stationary housing plate adjacent the blade and parallel to the direction is displaceable perpendicular to the direction to set slice thickness. A slide plate on the slide extends perpendicular to the direction and serves to orient the foodstuff, which is normally elongated, so that it extends transversely of the direction and so that the slices are cut off its end. In addition a pusher on the slide presses the foodstuff perpendicular to the direction against a front face of the housing plate. Each time the slide is stroked past the blade, a slice is cut off and normally drops on the back side of the device.

Modern such slicing machines are provided with drives that automatically reciprocate the slide past the blade. In addition a catch table on the back side of the housing plate can be synchronized to move along with a picking device to set down the cut slices in a predetermined array.

As with any production machine, the user needs to let the machine do the maximum amount of work. Thus the standard procedure is for the user to carefully orient the elongated foodstuff on the slide lying against the slide plate, and then the machine can be turned on to produce the desired number or weight of slices in the desired array.

### OBJECTS OF THE INVENTION

It is therefore an object of the present invention to provide an improved slicing machine with automatic product alignment.

Another object is the provision of such an improved slicing machine with automatic product alignment that overcomes the above-given disadvantages, in particular that makes it easier for the user to set up a slicing job.

### SUMMARY OF THE INVENTION

A slicing machine has according to the invention a blade displaceable on a housing, an upright housing plate on the housing extending substantially parallel to a cutting direction adjacent the blade, and a slide adapted to support a foodstuff to be sliced, displaceable horizontally generally parallel to the direction on the housing past the blade, and having an upright holding face extending generally perpendicular to the direction so that an elongated foodstuff resting lengthwise against the alignment face is sliced as the slide moves past the blade. An array of generally parallel and horizontal alignment bars oriented in an upright plane extending generally parallel to the holding face on the slide are displaceable parallel to the direction relative to the holding face. An alignment guide or drive allows movement of the alignment bars generally parallel to the direction toward the holding face and thereby pressing and aligning of the foodstuff thereagainst. An array of generally parallel and horizontal pusher bars oriented in an upright plane extending generally parallel to the direction mesh with and cross the alignment bars and are displaceable horizontally generally perpendicular to the direction relative to the housing plate. A pusher drive or guide connected to the pusher bars allows movement of same perpendicular to the direction toward the housing plate and thereby pressing of the foodstuff between the alignment bars and the holding face toward the housing plate.

Thus with this system the user does not have to carefully fit the foodstuff to the slide, butting it endwise against the housing plate and pressing it parallel against the slide plate. Instead the foodstuff is simply dropped into the upwardly open space formed between the slide plate, the housing plate, and the two arrays of bars. Then the alignment bars are moved in to press the foodstuff lengthwise against the slide plate, and the pusher bars are moved in to press the foodstuff endwise against the housing plate.

The drives each include a respective electric motor connected to the respective bars with a chain, belt, or threaded-spindle system serving to actually shift the respective bar array. Thus the two-step orientation of the foodstuff can be done wholly automatically. This eliminates another job for the user of the slicing machine, virtually leaving the user with nothing to do but load the machine with the desired foodstuff and then set the slice thickness and batch size. From there the machine takes over.

The slicing machine thus has according to the invention a controller connected to the drives for displacing the alignment bars toward the slide plate to press the foodstuff thereagainst while maintaining the pusher bars stationary, and thereafter displacing the pusher bars toward the housing plate to press the foodstuff thereagainst.

The controller can detect current consumption of the motors and stopping the motors when a predetermined level of current consumption is reached. Thus the arrays of bars will stop once they have gotten the foodstuff into the desired position. In fact according to the invention the controller monitors a position of the array of alignment bars and s establishes the predetermined cutoff level in dependence on spacing of the alignment-bar array from the slide plates such that a higher level is used with larger spacing. In this manner normally durable large-diameter foodstuffs are pressed more forcibly against the carriage plate than normally more fragile small-diameter foodstuffs.

### BRIEF DESCRIPTION OF THE DRAWING

The above and other objects, features, and advantages will become more readily apparent from the following description, reference being made to the accompanying drawing in which:

FIG. 1 is a small-scale and partly diagrammatic end view of a slicing machine according to the invention;

FIG. 2 is a partly diagrammatic top view of the slide assembly in accordance with the invention; and

FIGS. 3 and 4 are perspective views of a portion of the apparatus showing the operation of the alignment and pusher devices.

### SPECIFIC DESCRIPTION

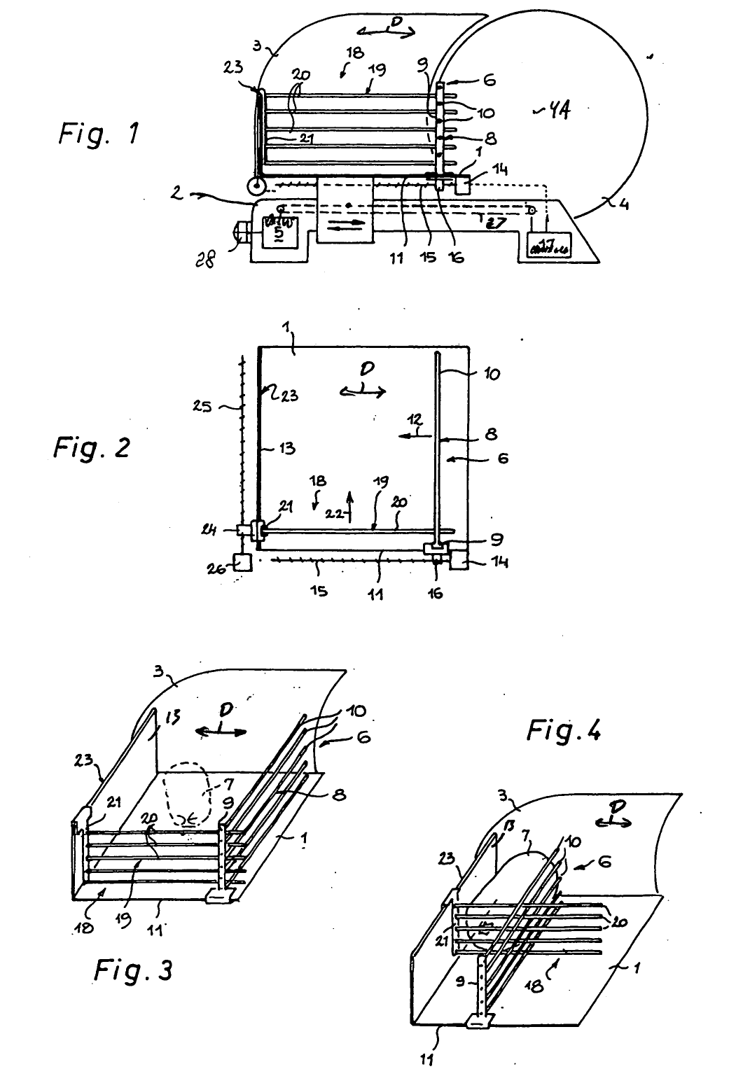

As seen in FIGS. 1 and 2, a slicing machine has a housing 2 on which a generally flat and planar table or slide 1 can be moved horizontally in a direction D along an upright housing plate 3 and past a circular blade 4 normally rotated about a horizontal axis 4A perpendicular to the plate 3 and to the direction D. A drive 5 in the housing is connected through a belt assembly 27 with the slide 2 to move it back and forth, either once in single-slice mode or many times in multiple-slice mode as determined by setting made at a control head 28. The slide 1 has an upright and generally planar slide plate 13 that extends perpendicular to the direction D and that serves both as a handle for manual actuation of the slide 1 and an abutment against which an elongated foodstuff 7 (FIGS. 3 and 4) is held during a slicing operation. This is all generally standard.

According to the invention a device 6 is provided for aligning and orienting the foodstuff 7 so it extends lengthwise of the slide plate 13 and is seated thereagainst during the cutting operation. This device 6 comprises a fence or rake 8 formed by an upright array of horizontal bars or tines 10 extending perpendicular to the direction D and fixed at outer ends on a support 9 slidable along a guide 11 formed by an outer edge of the slide 1. This rake 8 can move in a direction 12 toward the slide plate 13. This is effected by an electric motor 14 carried on the slide 1 and having a spindle 15 threaded into a coupling block 16 on the support 9. The motor 14 is connected to a controller 17 in the housing 2 that not only turns it on and off, but that also monitors the position of the rake 8 and the current consumption of the motor 14.

The purpose of this device 6 is to align the elongated foodstuff 7 parallel to the plate 13 and to press it thereagainst. Thus the user need merely drop the foodstuff 7 between the rake 8 and the plate 13, in any position other than parallel to the direction D, and actuate the drive 14. The rake 8 will move in from the position of FIG. 3 to that of FIG. 4 and press the foodstuff 7 against the plate 13, shifting it from a position extending at an acute angle to the plate 13 to one perfectly parallel thereto and bearing flatly thereagainst. When the foodstuff 7 is solidly in place, further advance of the rake 8 will be blocked, causing the current consumption of the motor 14 to spike, whereupon the controller 17 will shut this motor 14 off. This operation can be repeated with each slice cut, or only once at the start of a batch slicing operation. In addition, when the machine has been set to automatically produce a batch having a predetermined number of slices and/or weight of slices, the controller 17 retracts the rake 8 back to the FIG. 3 starting position when the operation is complete.

As a result of monitoring the motor 14, the controller 17 knows the position of the rake 8. This information can be used to gauge slice diameter in a machine that arrays the slices after they are cut or that is set to estimate weight. It can also be used to determine how forcibly the motor 14 will press the rake 8 against the foodstuff, as normally smaller-diameter foodstuffs, e.g. sausage, are more fragile than larger-diameter foodstuffs, e.g. mortadella. Thus the pressure exerted in the direction 12 against the foodstuff 7 can be tailored to its size and fragility.

In addition a pusher device 18 is provided for pressing the foodstuff 7 perpendicular to the direction D against the housing plate 3. This device 18 comprises a fence or rake 19 formed by an upright array of horizontal bars or tines 20 extending parallel to the direction D and fixed at outer ends on a support 21 slidable along a guide 23 formed by an upper edge of the slide plate 13 of the slide 1. The tines 20 fit between and cross the tines 10. This rake 19 can move independently of the rake 8 in a direction 22 perpendicular to the direction D toward the housing plate 3. This is effected by an electric motor 26 carried on the slide 1 and having a spindle 25 threaded into a coupling block 24 on the support 21. The motor 26 is connected to the controller 17 in the housing 2 that not only turns it on and off, but that also monitors the position of the rake 19 and the current consumption of the motor 22.

The purpose of this device 18 is to press the aligned elongated foodstuff 7 toward the plate 3. Thus once the device 6 has aligned the foodstuff 7 with the plate 13, the rake 19 will move in from the position of FIG. 3 to that of FIG. 4 and press the foodstuff 7 against the plate 3. When the foodstuff 7 is solidly in place, it will block further advance of the rake 19, causing the current consumption of the motor 22 to spike, whereupon the controller 17 will shut this motor 22 off. As a result of monitoring operation of the motor 22, the controller 17 will know the position of the rake 19. This information can be used to automatically stop the slicing when the foodstuff 7 is depleted. Normally the motor 26 is energized once in each slice cycle to advance the foodstuff 7 toward the plate 3. Like the rake 8, the rake 19 is retracted at the end of a slicing operation so the user can easily unload the machine.

1. A slicing machine comprising:
a housing;
a blade displaceable on the housing;
an upright housing plate on the housing extending substantially parallel to a cutting direction adjacent the blade;
a slide adapted to support a foodstuff to be sliced, displaceable horizontally generally parallel to the direction on the housing past the blade, and having an upright holding face extending generally perpendicular to the direction, whereby an elongated foodstuff resting lengthwise against the alignment face is sliced as the slide moves past the blade;
an array of generally parallel and horizontal alignment bars oriented in an upright plane extending generally parallel to the holding face on the slide and displaceable parallel to the direction relative to the holding face;
alignment drive means for moving the alignment bars generally parallel to the direction toward the holding face and thereby pressing and aligning the foodstuff thereagainst;
an array of generally parallel and horizontal pusher bars oriented in an upright plane extending generally parallel to the direction, meshing with and crossing the alignment bars, and displaceable horizontally generally perpendicular to the direction relative to the housing plate; and
pusher drive means connected to the pusher bars for moving same perpendicular to the direction toward the housing plate and thereby pressing the foodstuff between the alignment bars and the holding face toward the housing plate.

2. The slicing machine defined in claim 1 wherein the drive means each include a respective electric motor connected to the respective bars.

3. The slicing machine defined in claim 1, further comprising
control means connected to the drive means for
displacing the alignment bars toward the slide plate to press the foodstuff thereagainst while maintaining the pusher bars stationary, and thereafter
displacing the pusher bars toward the housing plate to press the foodstuff thereagainst.

4. The slicing machine defined in claim 3 wherein each of the drive means includes a respective electric motor connected to the respective bars, the control means including means for detecting current consumption of the motors and for stopping the motors when a predetermined level of current consumption is reached.

5. The slicing machine defined in claim 4 wherein the control means monitors a position of the array of alignment bars and establishes the predetermined level in dependence on spacing of the alignment-bar array from the slide plates such that a higher level is used with larger spacing.
